(19) United States
(12) Patent Application Publication
(10) Pub. No.: US 2009/0082706 A1
(43) Pub. Date: Mar. 26, 2009

(54) Shower head attachment with a pulsator used to clean teeth

(75) Inventor: Daniel A. Shaw, Naples, FL (US)

Correspondence Address: ALLEN D. BRUFSKY, P.A., 475 Galleon Drive, Naples, FL, 34102, US

(73) Assignee: HEALTH AND HYGIENE INC.

(21) Appl. No.: 11/900,764

(22) Filed: Sep. 13, 2007

(51) Int. Cl. A61C 17/16

(52) U.S. Cl. 601/165

(57) ABSTRACT

A valve for adjusting the flow of water through an oral irrigation device is connected to a shower head by a flexible conduit. The valve is located on a handle connected to a water-dispensing pick for cleaning teeth and gums. An impeller-type pump is provided in the flexible conduit to pulsate the water.

### BACKGROUND OF THE INVENTION

1. Field of the Invention

This invention relates to a dental hygiene device, and more particularly to a syringe for delivering a stream of water for cleaning the teeth and gums of a user while showering in combination with an accessory designed to deliver the water in a pulsating manner.

2. Description of Prior Art

Numerous methods and apparatus have been suggested for cleaning the teeth and gums by using a jet stream of water.

One widely accepted system involves the use of a jet of water fed to a hand held syringe by an electrically driven pump placed beside a bathroom sink. This system requires a relatively expensive electrically driven pumping mechanism and the use of space adjacent the sink or water basin.

Therefore, it has been suggested that it would be less time consuming and less expensive to clean one's teeth and gums with a stream of water in a shower stall rather than over a sink. Different forms of apparatus designed to utilize an oral syringe in a shower are illustrated in U.S. Pat. Nos. 4,043,337; 4,265,229; 4,564,005; and 4,793,331. However, each of these systems requires a valve at the shower head to divert and redirect the stream of water through the syringe. For disabled persons in a wheelchair or for short people this is a distinct disadvantage negating their use of the device because they cannot reach the valve. Further, diverting the stream at the shower head requires some sort of pressure-lowering mechanism, so the full stream is diverted from the shower head to the cleaning unit and the shower flow is stopped. So the full stream can be used for teeth or gum cleaning. Nor are these devices readily subject to disassembly to replace worn or inoperable parts. In my copending application, Ser. No. 11/238,614, filed Sep. 29, 2005, assigned to the same assignee as this application, I disclose a shower head attachment which overcomes the deficiencies of the prior art.

In my copending patent application, the disclosure of which is incorporated herein by reference, a valve for adjusting the flow of water through the device is located on the handle connected to the water-dispensing pick. Rotation of the valve controls the amount and pressure of water dispensed through the pick in a direct stream from the shower head. The valve and its components are threadedly connected between the pick and handle of the device and can be readily disassembled to replace any worn parts.

Furthermore, many users find it desirable to provide a pulsating stream, which is used to stimulate the gums of the user, without abrogating the cleaning function of the water stream. This invention discloses such a pulsator which can be used upstream of the water dispensing pick.

### SUMMARY OF THE INVENTION

In accordance with the invention, a rotatable valve is placed in the water delivery line between the shower head and water streaming pick assembly. The valve includes an impeller having radially extending blades seated by a ring on a centrally located hub in a capped housing. Water from the shower head is conducted through a flexible conduit into the housing where it is directed by a pair of baffles to contact the radial impeller blades of the valve to cause the blades to rotate, which pushes the inflow into a pair of drain openings provided in the floor of the housing, which are sequentially opened and closed by the rotating impeller blades to create a pulsating effect on the water flow egressing from the drain openings and into a continuation conduit connected to the water pick upstream from the pick.

### BRIEF DESCRIPTION OF THE DRAWINGS

Further objects and advantages of the invention will become more apparent from the following description and claims and from the accompanying drawings, wherein:

FIG. 1 is a fragmentary perspective view of a shower head attachment to which the pulsating apparatus of the present invention can be attached;

FIG. 2 is a longitudinal cross-sectional view of the shower head attachment of FIG. 1;

FIG. 3 is an exploded cross-sectional view of the components of the shower head attachment of FIG. 3;

FIG. 4 is a cross-sectional view of the components of the pulsating apparatus of the present invention, which can be used with the shower head attachment of FIG. 1, with its cover element removed; and

FIG. 5 is an exploded cross-sectional view taken substantially along the plane indicated by line 5-5 of FIG. 4.

### DETAILED DESCRIPTION OF THE PREFERRED EMBODIMENT

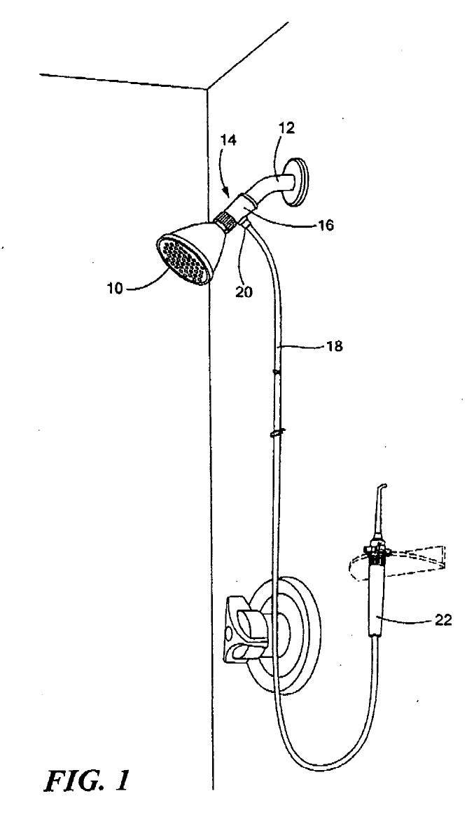

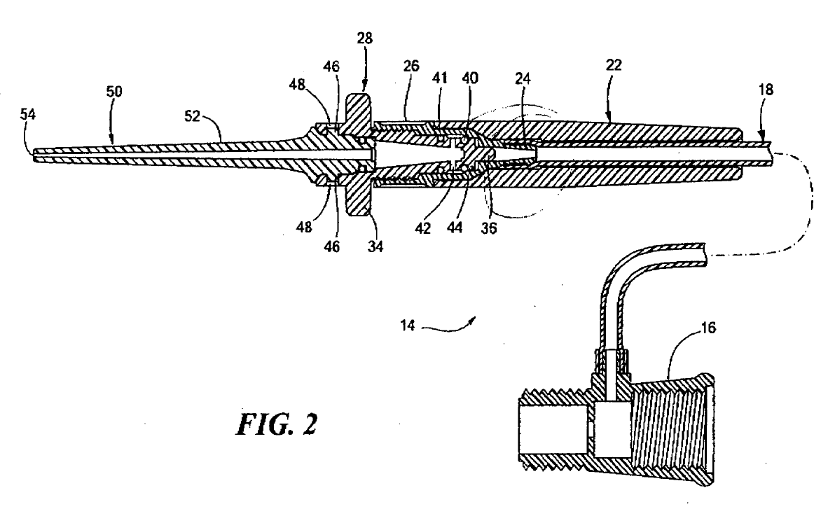

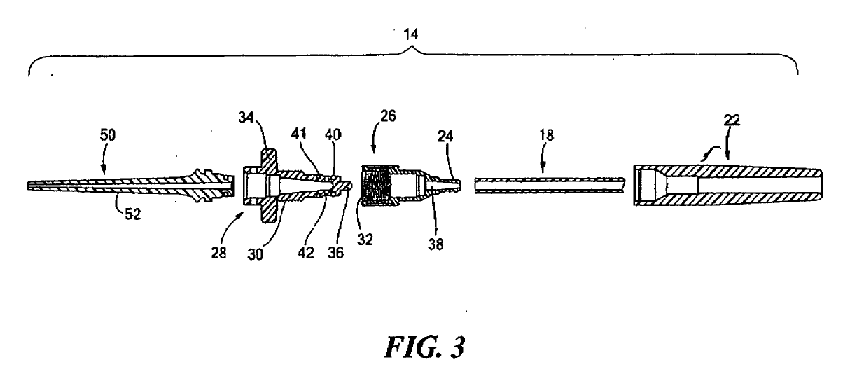

Referring now to the drawings in detail, wherein like numerals indicate like parts throughout the several views, and in particular FIG. 1, a shower stall is illustrated which includes a conventional shower head 10, which receives water under pressure from inlet pipe 12. An oral irrigating assembly 14 in accordance with the present invention is interposed between shower head 10 and inlet pipe 12.

The assembly 14 includes a fixture 16 threadedly connected to inlet pipe 12 at one end and the shower head 10 at its opposite end. A flexible conduit 18 is fixed at one end to fixture 16, which has an opening 20 in communication with the interior of fixture 16. The distal end of flexible conduit 18 is received within the interior of a handle component 22 and connected over the serrated end 24 of a housing 26.

The housing 26 threadedly receives a valve 28 having a threaded cylindrical portion 30, received in threaded engagement with a complementary threaded portion 32 within housing 26. Rotation of threaded portion 30 by means of a handle 34 moves the valve element 28 linearly, relatively out of housing 26, while rotation in an opposite direction moves the valve linearly into the housing.

At the end of valve 28 is a nipple 36 which seats within the bore 38 of housing 26 and blocks then the ingress of water from conduit 18 through the handle component 22. Rotation of the handle to open the valve, by moving it out of the housing, moves the nipple 36 out of bore 38. This enable water to enter the housing 26, flow around the nipple 36, past an O-ring seal 40 and against O-ring seal 41 on the valve and through an opening 42 into the interior of the housing. Depending on the distance of travel of the valve relative to the housing, the pressure and amount of the water delivered through opening 42 can be varied. To preclude the ingress of water from conduit 18 through valve 28, the valve handle is turned in an opposite direction until O-ring seal 40 seats on housing valve seat 44, effectively shutting the valve and precluding the ingress of water through the housing 26.

Connected to valve 28 by a pair of oppositely extending projections 46 received in openings 48 on valve 28 is a syringe or water pick 50 having an elongated nozzle 52. provided with an opening 54. Water streaming through valve 28 emanating from shower head 10 is conducted through the interior of nozzle 52 against the teeth and/or gums of a user to clean the same.

It will be understood that the components of the apparatus are completely disassemble and the individual components as well as the O-ring seals may be replaced when worn as needed.

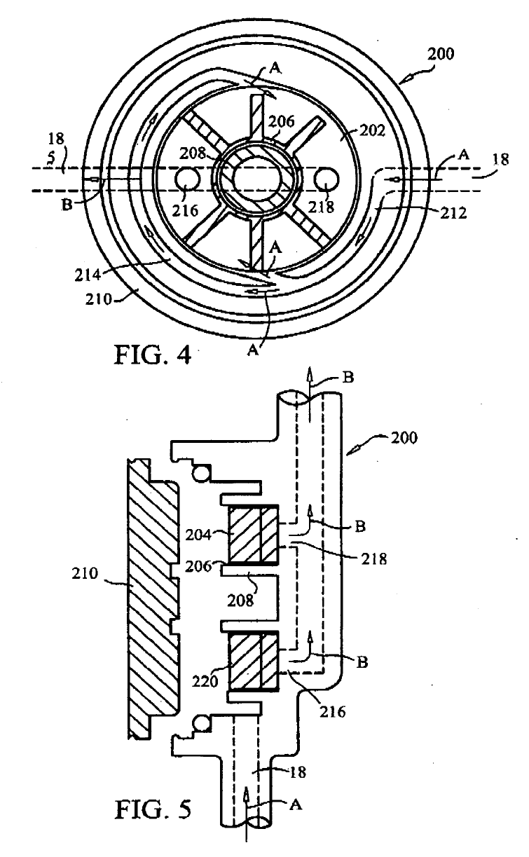

Referring now to FIGS. 4 and 5, a valve 200 is placed in the water delivery line 18 between the shower head and water streaming pick assembly. The valve 200 includes an impeller 202 having radially extending blades 204 seated by a ring 206 on a centrally located hub 208 in a capped housing 210. Water from the shower head is conducted through the flexible conduit 18 into the housing 210, as indicated by the arrows A in FIGS. 4 and 5 where it is directed by a pair of integral baffles 212, 214 to contact the radial impeller blades 204 of the valve 200, which in turn pushes the inflow as indicated by the arrows B into a pair of drain openings 216, 218 provided in the floor 220 of the housing 210 which are sequentially opened and closed by the rotating impeller blades 204 to create a pulsating effect on the water flow egressing from the drain openings 216, 218 and into a continuation conduit 18 connected to the water pick upstream from the pick.

1. Dental cleaning apparatus for coupling between a water outlet and a showerhead, said apparatus comprising:
a fixture between said water outlet and showerhead for diverting water from said water outlet,
a conduit in fluid communication with said fixture to receive diverted water from said water outlet,
a handle element communicating with an opposite end said flexible conduit to receive the diverted water,
a valve body provided with a handle portion received within said handle including
means for precluding communication of said handle element with said conduit upon movement in one direction, but enabling communication upon movement in an opposite direction,
an oral irrigator coupled to said valve body for transmitting a jet of water to a user of the apparatus upon movement of said valve body enabling communication between said handle element and flexible conduit, and
means in fluid communication with said conduit upstream from said handle element for creating a pulsing effect of the water transmitted to a user of the apparatus.

2. Dental cleaning apparatus according to claim 1 wherein said pulsing means includes
a housing having a first opening for receiving water from said conduit and
at least one second opening for dispensing water from said housing back to said conduit, and
a rotating valve which directs water sequentially from said first to said second opening.

3. Dental apparatus in accordance with claim 2 wherein said valve includes a series of radially extending impeller blades said impeller blades being positioned in said housing to sequentially open and close said second opening.

4. Dental cleaning apparatus in accordance with claim 3 wherein said housing includes baffles for directing said water flowing into said housing to impinge on said radial impeller blades.

5. Dental cleaning apparatus in accordance with claim 2 wherein said housing includes baffles for directing water flowing into said housing to said valve.
